(19) United States
(12) Patent Application Publication
(10) Pub. No.: US 2015/0028113 A1
(43) Pub. Date: Jan. 29, 2015

(54) ZONE TEMPERATURE CONTROL SYSTEM

(71) Applicant: Smart Stuff, Inc., Summerville, SC (US)

(72) Inventor: Richard Day, Summerville, SC (US)

(73) Assignee: Smart Stuff, Inc., Summerville, SC (US)

(21) Appl. No.: 13/952,821

(22) Filed: Jul. 29, 2013

(51) Int. Cl. G05D 23/19

(52) U.S. Cl. CPC G05D 23/19
USPC 236/51

(57) ABSTRACT

A programmable central server wirelessly communicates with a plurality of temperature sensors. The temperature sensors are positioned within spaced apart zones within a building. The temperature sensors sense the temperature within the zone in which the temperature sensor is located. Each of the temperature sensors periodically and wirelessly reports a temperature in the zone of the building in which the individual sensor is assigned and located. The temperature sensors instruct the central server to activate or deactivate a heating and air conditioning device and instruct associated dampers to open or close, based on the temperature measured by the temperature sensors, and based upon the desired temperature programmed into the central server, thus maintaining a required temperature in virtual zones.

### FIELD OF THE INVENTION

This invention relates to controls for heating and cooling systems for buildings.

### BACKGROUND OF THE INVENTION

Temperature control in buildings is commonly performed by a thermostat positioned on a wall or walls of a building. The thermostat senses the temperature at the thermostat. The thermostat is connected, typically by wiring, to a heating and cooling system, commonly known as an HVAC system. In larger houses, offices and other buildings, individual rooms, offices or areas each have wall thermostats. Each thermostat communicates with an HVAC system.

There is a need for a control system for heating and cooling systems, or HVAC systems, that is wirelessly and centrally programmed to control the temperature in each room, office, or other zone (collectively or individually referred to herein as “zone”) of a building.

### SUMMARY OF THE INVENTION

The present invention includes a programmable central server that wirelessly communicates with a plurality of temperature sensors. The temperature sensors are positioned within spaced apart zones within a building. The temperature sensors sense the temperature within the zone in which the temperature sensor is located. Each of the temperature sensors periodically and wirelessly reports a temperature in the zone of the building in which the individual sensor is assigned and located. The temperature sensors instruct the central server to activate or deactivate a heating and air conditioning device based on the temperature measured by the temperature sensor, and based upon the desired temperature programmed into the central server.

### BRIEF DRAWING DESCRIPTION

FIG. 1 is a schematic diagram demonstrating a central server wirelessly communicating with a plurality of spaced apart temperature sensors. Each of the spaced apart temperature sensors wirelessly communicate with damper(s) located in the same zone as the temperature sensor.

FIG. 2 is an elevation of a damper for a heating and air conditioning duct according to one embodiment of the invention.

FIG. 3 is a front elevation of an example of a temperature sensor.

FIG. 4 is a side elevation of an example of the temperature sensor of FIG. 3.

FIG. 5 is a side elevation of an example of the temperature sensor of FIG. 3 opposite the side shown in FIG. 4.

FIG. 6 is an elevation of an example of internal components of a central server sensor according to an embodiment of the invention.

### DESCRIPTION OF PREFERRED EMBODIMENTS

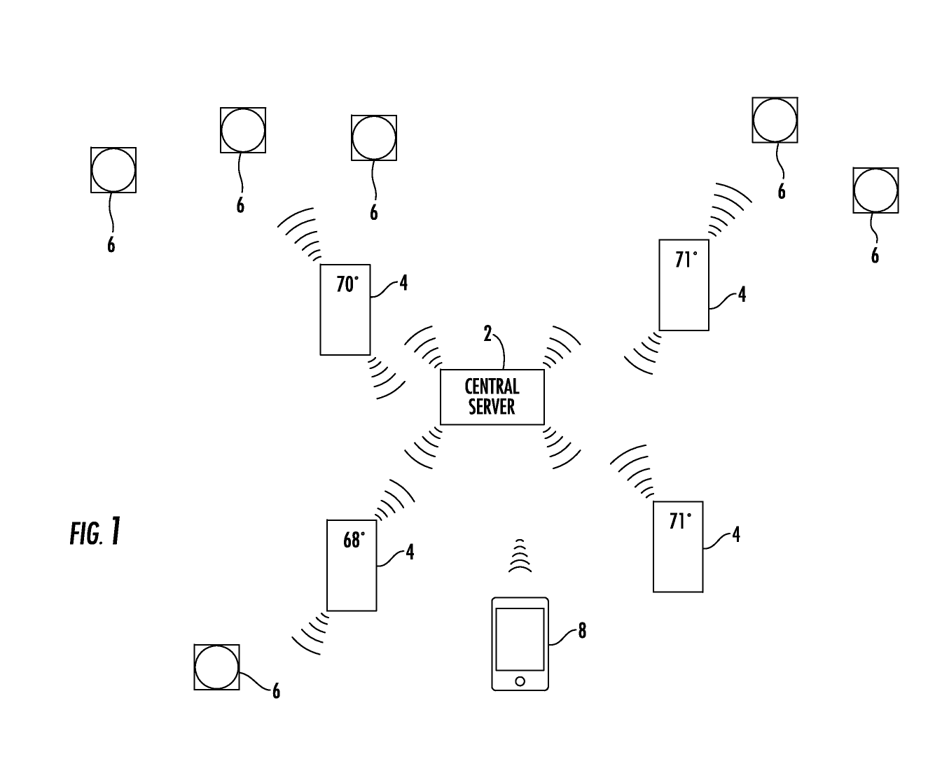

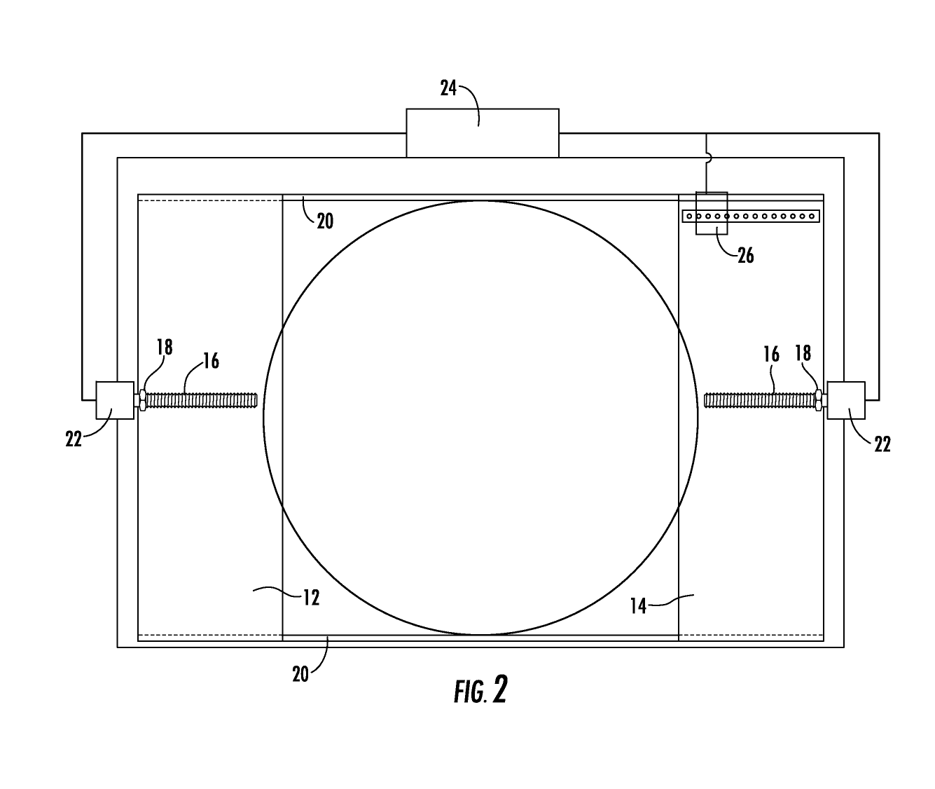

Referring now to FIG. 1, the central server 2 communicates with the heating and cooling, or HVAC, system or systems, of a building. The central server actuates, or terminates actuation of, some or all of the HVAC system based upon information received from the spaced apart temperature sensors 4. The central server may be connected to the HVAC system by wiring, or by a wireless communication system. The central server controls signals to the HVAC to actuate the HVAC system, which commonly employ twenty-four volt DC systems.

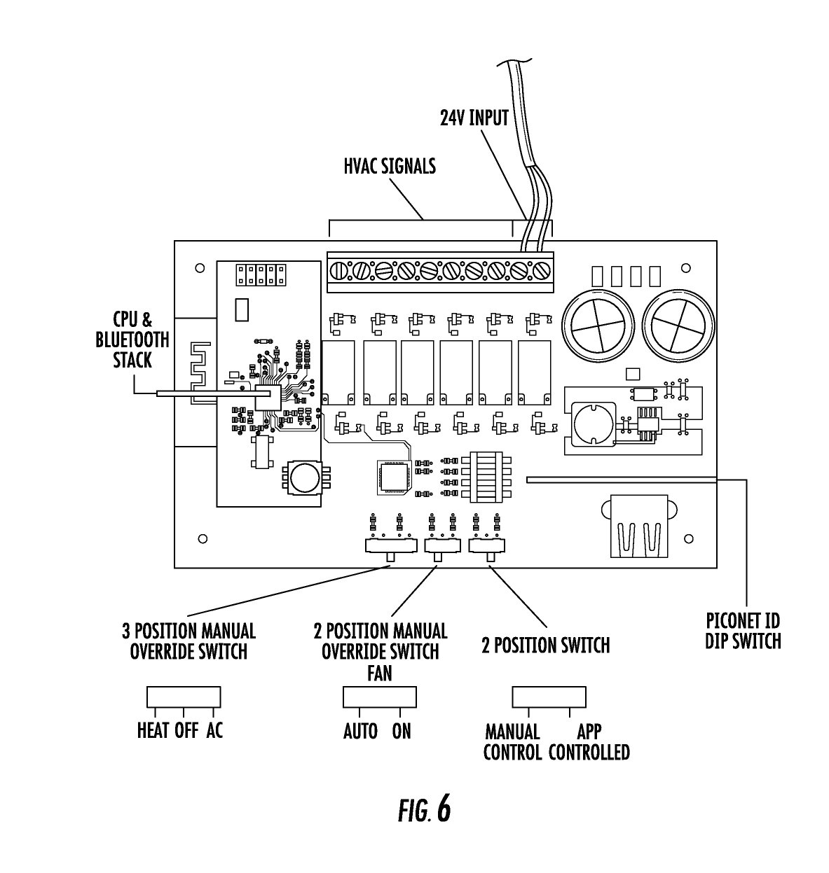

The central server may comprise a piconet ID dip switch. FIG. 6. The central server identifies information from each of the temperature sensors based upon the piconet identification code that is assigned to, and is unique to, each of the temperature sensors.

The central server is programmable, so that separate preferred temperatures are set for each zone by the temperature sensor assigned to and located in the zone. Further, the central server is programmable to activate, or deactivate, the HVAC system that is for a specific zone or zones during specific time periods. By way of example, the central server may be programmed to deactivate a zone at night and/or on weekends, when no one is occupying offices that are located in the zone. It is preferred that, at a minimum, a central server be programmable for repetitive seven day periods, such that the central server can be repetitively programmed for each day and for each portion of each day of the week. Alternatively, the central server may be programmable for longer periods, such as one month, or even annual periods.

It is preferred that the central server operates as a server in a client server networking relationship with the other components in the system as described herein. The central server contains the database for the controls for the system as described herein.

In a preferred embodiment, the central server is wirelessly programmable to receive and hold as data the programmed temperature for each zone, and to receive and hold data for the active or inactive time periods for each zone. Wireless communication to the central server may be provided by infrared or radio frequency communications. In a preferred embodiment, programming is provided to the central server by an application that is present on a smart phone. Wireless communication may be provided to the central server by a Bluetooth® enabled device, and provided by Bluetooth communication from digital devices such as a smart phone, tablet, or computer having Bluetooth capability. In the event that a wireless device, such as a smart phone, is not available, the central server may be provided with physical (hardware) human interface, such as a keypad and/or physical switches located on the face of the programmable central server for direct input of programming information to the programmable central server. FIG. 6. For example, manual overrides may be provided for the HVAC mode, the fan mode, and the thermostat control mode (manual or application controlled).

In a preferred embodiment, the programmable central server has connectivity to a minimum of five clients. For example, one client may be the remote communication device, such as the smart phone 8, and the other four clients may be the spaced apart temperature sensors 6 that are each located in a zone.

In a preferred embodiment, communication with the programmable central server by the remote device, such as a smart phone, and between the programmable central server and the temperature sensors is by Bluetooth Low Energy (BLE) technology, branded as Bluetooth SMART. FIG. 6. BLE technology employs a generic attribute profile (GATT) and allows the programmable central server and the temperature sensors to operate for an extended period of several months on a button cell (watch) battery.

The programmable central server receives may be a generic access profile (GAP) device that receives communications from a plurality of temperature sensors. The temperature sensors are located in spaced apart zones within a building. A temperature sensor can be assigned to a first room or office, a second temperature sensor assigned to a second room or office that is remote from the first, and so on. However, temperature sensors may be located in large open areas, and spaced apart so that each temperature sensor measures the temperature within its assigned zone.

The temperature sensors sense the temperature in their respective zones, and each wirelessly communicates the temperature in the assigned zone of the temperature sensor to the central server. If the temperature is outside of a temperature range that is programmed into the programmable central server, then the temperature sensor commands the central server to actuate the HVAC system associated with that zone, if the corresponding HVAC system is not already actuated. For example, if a heating temperature range of 70° F. (21° C.) is programmed into the programmable central server, and a cooling range of 74 (23° C.) degrees is programmed into the programmable central server, and the temperature detected by the temperature sensor is above or below that range, then the temperature sensor will command the central server of the associated HVAC system to provide heating or cooling through the duct work associated with the zone from which the temperature sensor is reporting.

The temperature sensor operates as a client in the client server network in relationship with the programmable central server. The temperature sensor contains a sensor specific database learned from the programmable central server, as a result of the temperature sensor communicating wirelessly with the programmable central server, in a preferred embodiment. The temperature sensor includes logic to instruct the programmable central server to operate the associated HVAC system.

In a preferred embodiment, the temperature sensors control assigned dampers 6 within associated zones via wireless communication. While the programmable central server actuates the associated HVAC system, causing the HVAC system to provide heated or cooled air to associated duct work, in one embodiment, the heated or cooled air does not enter the associated room or zone until the damper opens upon command received from the temperature sensor.

In a preferred embodiment, each temperature sensor communicates with the programmable central server and with the assigned damper or dampers BLE communication. Each temperature sensor communicates periodically transmits its signal with unique identification to the programmable central server. Depending upon the data and associated temperature, the central server actuates, terminates actuation of, or takes no action regarding the operation of the associated HVAC system(s). If the temperature in a zone is above or below the range programmed for the zone into the central server, such that heated or cooled air is to be provided to the zone by the HVAC system, the temperature sensor wirelessly communicates a command to a damper or dampers to open, whereupon heated or cooled air is provided as required to the zone associated with the temperature sensor. Since the HVAC system may provide heated or cooled air to one or more additional zones and associated temperature sensors, when the required temperature is sensed within the zone by the temperature sensor, the temperature sensor will wirelessly communicate a signal to close the damper or dampers with which it is associated and which it communicates, while the HVAC system may continue to operate to provide heated or cooled air to one or more additional zones.

The central server need not be physically accessed with regularity, unlike a thermostat. Therefore, the device may be positioned out of sight, such as in a closet.

The temperature sensors may be GAP Peripheral/Broadcaster devices that are GATT clients to the central server, which is preferred in such an embodiment to be a GAP Central device. Each temperature sensor has a separate piconet identification that is recognized by the central server. The temperature sensors are preferred to include a battery strength indicator. Alternatively, the temperature sensors may be GAP Central/Broadcaster devices, and the central server is preferred in the alternative embodiment to be a GAP Peripheral device, with the piconet identification roles applied accordingly.

In a preferred embodiment, motion sensors 30 are included. It is preferred that at least one motion sensor is included in each zone in which a temperature sensor 4 is located. The motion detector may be part of, or may communicate with, the temperature sensor for the zone. If no motion is detected in the zone for a pre-determined period, such as, four hours, then the temperature sensor enters an inactive state until motion is sensed in the area. Alternatively, the programmable central server may be programmed so that the temperature is maintained at a first level if motion is sensed within the zone during the pre-determined time period, with a different temperature (second level) setting for actuation of the HVAC system if no motion is sensed within the area for the pre-determined time period.

The face 32 of the temperature sensor is preferred to provide visual information to the user. FIG. 3. The face 32 may be an LCD screen, or LED device, or other devices that provide visual information. Exemplary information may include the signal strength 34 of the piconet or other wireless communication, the current operating mode 36 (i.e. heat, fan or air conditioning), day (or date) and time 38, current operating period 40 (i.e. wake, leave, return, sleep), current temperature 42, desired temperature 44, operating status 46 (manual, application, automatic, sleep). Similar information may be communicated for display on the remote, such as the smart phone, that is used to program the programmable central server.

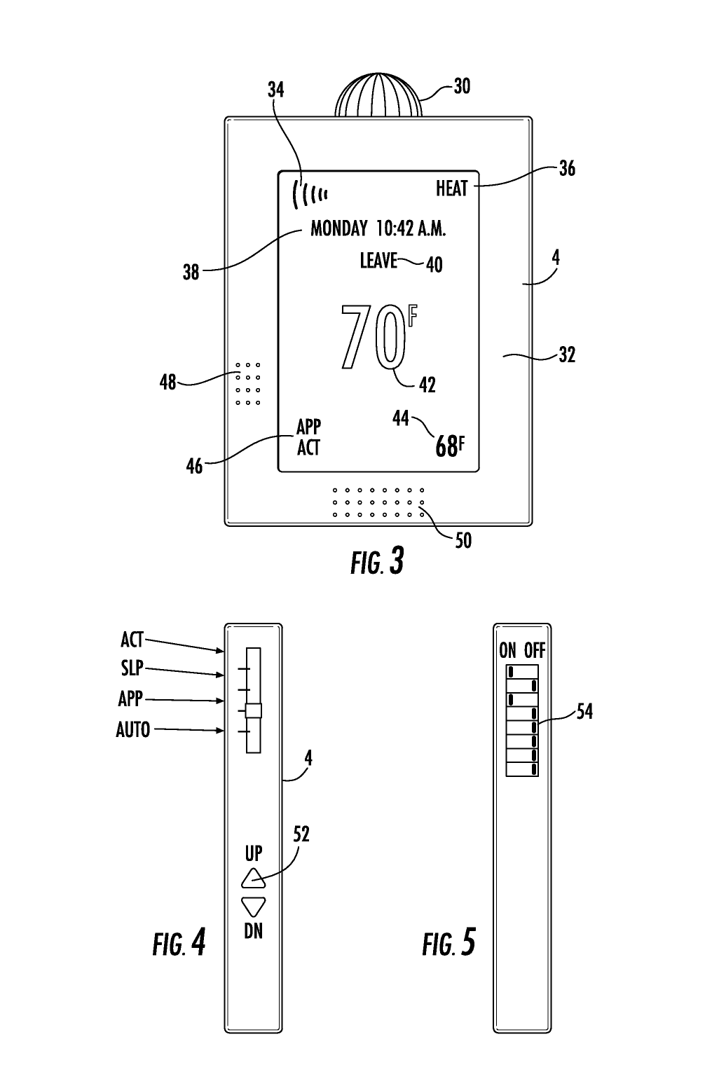

A temperature sensing device may communicate through the face 32, such as voids 48, with voids 50 for receiving a signal such as by an antenna or an infrared (IR) receiver. A temperature override 52 may be provided. FIG. 4. In the preferred embodiment, a piconet identification is defined by a multiple position dip switch 54, such as the 8 position dip switch show in FIG. 5.

In a preferred embodiment, the ducts are used to control distribution of heated and cooled air. More specifically, dampers may be used to permit or prevent heated or cooled air from the HVAC system from entering a zone. The dampers are opened or closed by a signal received from the temperature sensor associated with the zone. One or more dampers may be present within a zone. By way of example, and as shown in FIG. 1, one, two or three dampers may be provided within a zone according to the size and requirements of the zone. However, the number of dampers is not limited to a maximum of three.

In a preferred embodiment, the damper comprises opposing, slidable doors 12, 14. A first door and a second door each slide within a guide rail 20. The guide rail may be formed of nylon for minimizing noise and friction and for durability, but the guide rail could be formed of other materials. The opposing doors slide away from each other to move away from and open the duct, and slide toward each other to cover and close the duct. A gasket formed of a soft and pliable material may be present on the end of the duct to provide a seal between the duct and the opposing doors to reduce or prevent air from escaping the duct to any material degree when the doors are closed.

In a preferred embodiment, a motor 22 associated with each door causes a gear, such as a nylon screw 16, to rotate and to drive a fixed member, such as a threaded member 18, located on the door. The gear or screw causes the doors to open or close, depending on whether the rotation of the motor is clockwise or counter-clockwise, with the direction of rotation of the motor and screw controlled by a signal received by a receiver 24 from the temperature sensor.

In a preferred embodiment, the wireless signal from the temperature sensor to the damper is by BLE communication, with the communication devices being powered by a cell type battery. BLE technology provides extended battery life for the communication system. An encoder 26 for the BLE signal is provided. The damper may be a GAP Observer device.

Alternatively, since the damper is a fixture to the building, the damper, including the motors, may be connected to the building's electrical system. The motors for actuating the opposing doors may be twelve or twenty-four of the DC motors. The power may be provided from a transformer that is connected to the alternating current service of the building.

What is claimed:

1. A system for controlling heating and cooling in a building, comprising:
a plurality of spaced apart temperature sensors, wherein each of the temperature sensors of the plurality of spaced apart temperature sensors is positioned in an assigned virtual zone of a building, and wherein each of the spaced apart temperature sensors detects a temperature in its assigned virtual zone of the building;
a programmable central server that wirelessly communicates with each of the temperature sensors;
a plurality of dampers, wherein a damper of the plurality of dampers is positioned in each of the virtual zones of the building, and wherein each damper of the plurality of dampers corresponds to a spaced apart temperature sensors and each temperature sensor communicates wirelessly with its corresponding damper; and
wherein each of the spaced apart temperature sensors periodically wirelessly reports a temperature in the virtual zone of the building to which the temperature sensor is assigned and the temperature sensor instructs the central server to activate or deactivate a heating and air conditioning device based on the temperature measured by the temperature sensor.

2. The system for controlling heating and cooling in a building as described in claim 1, wherein the central server communicates with the reporting spaced apart temperature sensor, and the reporting spaced apart temperature sensor wirelessly communicates a command to the damper which corresponds to the reporting spaced apart temperature sensor.

3. The system for controlling heating and cooling in a building as described in claim 1, wherein each of the spaced apart temperature sensors has an assigned piconet identifier, and wherein the central server recognizes a periodic wireless signal from each of the spaced apart temperature sensors based upon the assigned piconet identifier.

4. The system for controlling heating and cooling in a building as described in claim 1, wherein a desired temperature for each virtual zone is programmed into the central server, and the central server communicates the programmed desired temperature to the temperature sensor for its assigned virtual zone.

5. The system for controlling heating and cooling in a building as described in claim 1, wherein each of the spaced apart temperature sensors comprises a motion sensor, and upon spaced apart temperature sensor sensing motion, the spaced apart temperature sensor is in an active mode for a predetermined period of time, and upon expiration of the predetermined period of time without sensing motion, the spaced apart temperature sensor is in an inactive mode, and while in inactive mode, the spaced apart temperature sensor does not send instructions to the central server.

6. The system for controlling heating and cooling in a building as described in claim 1, wherein the programmable central server is programmed wirelessly by a digital device.

7. The system for controlling heating and cooling in a building as described in claim 1, wherein the programmable central server is programmable for temperature settings for each of the temperature sensors, and the temperature settings may be programmed for each of the temperature sensors for a plurality of portions of a twenty four hour day.

8. The system for controlling heating and cooling in a building as described in claim 1, wherein the programmable central server is programmable for temperature settings for each of the temperature sensors, and the temperature settings are programmable for each of the temperature sensors for a plurality of portions of a twenty four hour day and for not less than seven days.

9. The system for controlling heating and cooling in a building as described in claim 1, wherein the wireless communication between the programmable central server and the plurality of temperature sensors is by Bluetooth Low Energy communication.

10. The system for controlling heating and cooling in a building as described in claim 1, wherein the programmable central server is programmed wirelessly by a smart phone application and the wireless communication between the smart phone and the programmable central server is by Bluetooth Low Energy communication.

11. The system for controlling heating and cooling in a building as described in claim 1, wherein the programmable central server is programmed wirelessly by infrared communication.

12. The system for controlling heating and cooling in a building as described in claim 1, wherein the programmable central server is programmed wirelessly by a digital device, and the digital device comprises a smart phone or table computer application that enables communication between the digital device and the programmable central server.

13. The system for controlling heating and cooling in a building as described in claim 1, wherein the programmable central server has connectivity to not less than five (5) temperature sensors.

14. The system for controlling heating and cooling in a building as described in claim 1, wherein each temperature sensor senses a temperature in its assigned zone, and each wirelessly reports data for the temperature sensed in the assigned zone to the central server, and wherein when a temperature is outside of a temperature range that is programmed into the programmable central server for the temperature sensor, the temperature sensor commands the central server to actuate the HVAC system associated with that zone

15. The system for controlling heating and cooling in a building as described in claim 1, wherein the wireless communication between the plurality of temperature sensors and the dampers is by Bluetooth Low Energy communication.

16. The system for controlling heating and cooling in a building as described in claim 1, further comprising a motion sensor that is located in each virtual zone of the building, and wherein the motion sensor communicates with the temperature sensor assigned to the virtual zone in which the motion sensor is located, and wherein after a predetermined time period elapses with no movement sensed within the assigned virtual zone, the temperature sensor assumes an inactive state.

17. The system for controlling heating and cooling in a building as described in claim 1, further comprising a motion sensor that is located in each virtual zone of the building, and wherein the motion sensor communicates with the temperature sensor assigned to the virtual zone in which the motion sensor is located, and wherein after a predetermined time period elapses with no movement sensed within the assigned virtual zone, the temperature sensor modifies a temperature that is maintained in the assigned virtual zone.

18. The system for controlling heating and cooling in a building as described in claim 1, wherein a damper comprises opposing doors that slide within a guide rail.
